(19) United States
(12) Patent Application Publication
(10) Pub. No.: US 2021/0203388 A1
(43) Pub. Date: Jul. 1, 2021

(54) BASE STATION APPARATUS, TERMINAL APPARATUS AND COMMUNICATION METHOD

(71) Applicant: SHARP KABUSHIKI KAISHA, Sakai City, Osaka (JP)

(72) Inventors: HIROMICHI TOMEBA, Sakai City (JP); RYOTA YAMADA, Sakai City (JP)

(73) Assignees: SHARP KABUSHIKI KAISHA, Sakai City, Osaka (JP); SHARP KABUSHIKI KAISHA, Sakai City, Osaka (JP)

(21) Appl. No.: 16/087,083

(22) PCT Filed: Feb. 28, 2017
(86) PCT No.: PCT/JP2017/007862

§ 371 Date: Sep. 20, 2018

(30) Foreign Application Priority Data
Mar. 31, 2016 (JP) 2016-070493

(51) Int. Cl. H04B 7/0417; H04B 7/06; H04L 5/00

(52) U.S. Cl. CPC H04B 7/0421; H04L 5/0051; H04B 7/0626

(57) ABSTRACT

Provided are a base station apparatus, a terminal apparatus, and a communication method that allows throughput to be improved in a case of using a large number of antennas. The base station of the present invention includes a transmitter configured to transmit a channel state information reference signal (CSI-RS) and configuration information of the CSI-RS to a terminal apparatus, and a receiving unit configured to receive the channel state information (CSI) related to the CSI-RS from the terminal apparatus, wherein the CSI-RS is a periodic CSI-RS transmitted periodically or an aperiodic CSI-RS transmitted aperiodically, and the configuration information of the CSI-RS includes information indicating a feedback information format for reporting the CSI.

### TECHNICAL FIELD

The present invention relates to a base station apparatus, a terminal apparatus, and a communication method.

### BACKGROUND ART

In a communication system such as LTE (Long Term Evolution) and LTE-A (LTE-Advanced) according to the 3GPP (Third Generation Partnership Project), a communication area can be expanded with a cellular configuration in which multiple areas are deployed in a cell-like manner, each area being covered by a base station apparatus (a base station, a transmitting station, a transmitting point, a downlink transmission device, an uplink reception device, a group of transmit antennas, a group of transmit antenna ports, a component carrier, an eNodeB) or a transmitting station equivalent to a base station apparatus. In such a cellular configuration, frequency utilization efficiency can be improved by using the same frequency among neighboring cells or sectors.

In recent years, a next generation mobile communication system has been studied. In the next generation mobile communication system, as described in NPL 1, technologies called Massive MIMO (Multiple Input Multiple Output) and Full Dimension (FD) MIMO that have a large number of antennas are studied. In Massive MIMO and FD MIMO, a large capacity transmission and a throughput improvement can be expected by the use of beamforming.

In a beamforming transmission, the transmitting station side needs to acquire channel state information (CSI) for the channel from the transmitting station to the receiving station. In the conventional LTE, a method is recommended that allows a codebook describing a plurality of linear filters to be shared between a transmitting station and a receiving station, and allows the receiving station to inform the transmitting station of a linear filter desirable for the receiving station. The transmitting station can improve the reception quality at the receiving station by multiplying the signal to the receiving station by the linear filter informed from the receiving station and performing the beamforming transmission. This scheme is called implicit channel state information feedback (Implicit CSI feedback) because the receiving station implicitly informs the channel state information between the transmitting station and the receiving information.

On the other hand, in the IEEE 802.11 standard, explicit CSI feedback (explicit CSI feedback) has been standardized that allows the receiving station to explicitly inform the channel state information between the transmitting station and the receiving station (Refer to NPL 2). The explicit channel state information feedback standardized in the IEEE 802.11 standard includes a method that allows the receiving station to directly quantize the channel matrix information which is an estimation result of the channel state information between the receiving station and the transmitting station, and inform the quantized information to the transmitting station.

### CITATION LIST

### NPL

NPL 1: 3 GPP RP-160623, March 2016.

NPL 2: IEEE Std 802.11 TM-2012, March 2012.

### SUMMARY OF INVENTION

### Technical Problem

However, since a significantly large number of antennas are used in Massive MIMO and FD MIMO described in NPL 1, a discrepancy becomes non-negligible, in the implicit channel state information feedback, between the channel state information informed from a receiving station to a transmitting station and the actual channel state information. In particular, in a multi-user spatial multiplexing transmission in which a transmitting station simultaneously transmits signals to a plurality of receiving stations, there is a problem of throughput degradation due to inter-user interference caused by discrepancy of channel state information.

On the other hand, since the explicit channel state information feedback allows the receiving station to inform the transmitting station of the channel state information more accurately than the implicit channel state information feedback, the interference between users due to the discrepancy of the channel state information is decreased. However, in the explicit channel state information feedback, since the receiving station informs the transmitting station of the information obtained by directly quantizing the channel state information, an increase of the overhead caused by the notification of the channel state information by the receiving station becomes non-negligible, causing a problem of throughput degradation.

The present invention has been made in view of such circumstances, and an object of the present invention is to provide a base station apparatus, a terminal apparatus, and a communication method that can improve throughput in a case that a large number of antennas are used.

### Solution to Problem

According to one embodiment of the present invention to solve the above problem, configurations for a base station apparatus, a terminal apparatus and a communication method are as follows.

(1) A base station apparatus according to one aspect of the present invention is a base station apparatus for communicating with a terminal apparatus, the base station apparatus including a transmitter configured to transmit a channel state information reference signal (CSI-RS) and configuration information of the CSI-RS to the terminal apparatus, and a receiver configured to receive channel state information (CSI) related to the CSI-RS from the terminal apparatus, wherein the CSI-RS is a periodic CSI-RS transmitted periodically or an aperiodic CSI-RS transmitted aperiodically, and the configuration information of the CSI-RS includes information indicating a feedback information format for reporting the CSI.

(2) In addition, the base station apparatus according to one aspect of the present invention is as described in the above (1), wherein the configuration information of the CSI-RS includes a CSI report type which is information indicating a type related to a report of the CSI, and a CSI-RS configuration information ID which is an ID of the configuration information of the CSI-RS, information of the periodic CSI-RS or information of the aperiodic CSI-RS, and the CSI report type and the CSI-RS configuration information ID, the information of the periodic CSI-RS or the information of the aperiodic CSI-RS are associated with the information indicating the feedback information format for reporting the CSI.

(3) In addition, the base station apparatus according to one aspect of the present invention is as described in the above (2), wherein the configuration information of the CSI-RS on the report of the CS according to an implicit feedback information format and the configuration information of the CSI-RS on the report of the CSI according to an explicit feedback information format are configured for the terminal apparatus.

(4) In addition, the base station apparatus according to one aspect of the present invention is as described in the above (3), wherein a CSI report cycle included in the configuration information of the CSI-RS on the report of the CSI according to the explicit feedback information format differs from a CSI report cycle included in the configuration information of the CSI-RS on the report of the CSI according to the implicit feedback information format.

(5) In addition, the base station apparatus according to one aspect of the present invention is as described in the above (3), wherein the report of the CST includes a wideband CSI report and a subband CSI report, and the implicit feedback information format is configured in the wideband CSI report, and the implicit feedback information format is configured in the subband CSI report.

(6) In addition, the base station apparatus according to one aspect of the present invention is as described in the above (3), wherein the explicit feedback information format includes analog feedback.

(7) A terminal apparatus according to one aspect of the present invention is an terminal apparatus for communicating with a base station apparatus, the terminal apparatus including a receiver configured to receive a channel state information reference signal (CSI-RS) and configuration information of the CSI-RS from the base station apparatus, and a transmitter configured to transmit channel state information (CSI) related to the CSI-RS to the base station apparatus, wherein the CSI-RS is a periodic CSI-RS transmitted periodically or an aperiodic CSI-RS transmitted aperiodically, and the configuration information of the CSI-RS includes information indicating a feedback information format for reporting the CSI.

(8) In addition, the terminal apparatus according to one aspect of the present invention is as described in the above (7), wherein the configuration information of the CSI-RS includes a CSI report type which is information indicating a type related to a report of the CSI, and a CSI-RS configuration information ID which is an ID of the configuration information of the CSI-RS, information of the periodic CSI-RS or information of the aperiodic CSI-RS, wherein the CSI report type and the CSI-RS configuration information ID, the information of the periodic CSI-RS or the information of the aperiodic CSI-RS are associated with information indicating a feedback information format for reporting the CSI.

(9) In addition, the terminal apparatus according to one aspect of the present invention is as described in the above (8), wherein the configuration information of the CSI-RS on the report of the CST according to an implicit feedback information format and the configuration information of the CSI-RS on the report of the CSI according to an explicit feedback information format are configured by the base station apparatus.

(10) In addition, the terminal apparatus according to one aspect of the present invention is as described in the above (9), wherein a CSI report cycle included in the configuration information of the CSI-RS on the report of the CSI according to the explicit feedback information format differs from a CSI report cycle included in the configuration information of the CSI-RS on the report of the CSI according to the implicit feedback information format.

(11) In addition, the terminal apparatus according to one aspect of the present invention is as described in the above (9), wherein the report of the CSI includes a wideband CSI report and a subband CSI report, and the implicit feedback information format is configured in the wideband CSI report, and the implicit feedback information format is configured in the subband CSI report.

(12) In addition, the terminal apparatus according to one aspect of the present invention is as described in the above (9), wherein the explicit feedback information format includes analog feedback.

(13) A communication method according to one aspect of the present invention is a method for a base station apparatus to communicate with a terminal apparatus, the method including the steps of transmitting, to the terminal apparatus, a channel state information reference signal (CSI-RS) and configuration information of the CSI-RS, and receiving channel state information (CSI) related to the CSI-RS from the terminal apparatus, wherein the CSI-RS is a periodic CSI-RS transmitted periodically or an aperiodic CSI-RS transmitted aperiodically, and the configuration information of the CSI-RS includes information indicating a feedback information format for reporting the CSI.

(14) A communication method according to one aspect of the present invention is a method for a terminal apparatus to communicate with a base station apparatus, the method comprising the steps of receiving, from the base station apparatus, a channel state information reference signal (CSI-RS) and configuration information of the CSI-RS, and transmitting channel state information (CSI) related to the CSI-RS to the base station apparatus, wherein the CSI-RS is a periodic CSI-RS transmitted periodically or an aperiodic CSI-RS transmitted aperiodically, and the configuration information of the CSI-RS includes information indicating a feedback information format for reporting the CSI.

### Advantageous Effects of Invention

According to one embodiment of the present invention, it is possible to prevent the overhead associated with the CSI report and improve the throughput.

### BRIEF DESCRIPTION OF DRAWINGS

FIG. 1 is a diagram illustrating an example of a communication system according to the present embodiment.

FIG. 2 is a diagram illustrating an example of a cycle of CSI report according to the present embodiment.

FIG. 3 is a block diagram illustrating a configuration example of a base station apparatus according to the present embodiment.

FIG. 4 is a block diagram illustrating a configuration example of a terminal apparatus according to the present embodiment.

### DESCRIPTION OF EMBODIMENTS

A communication system according to the present embodiment includes a base station apparatus (a transmission device, a cell, a transmission point, a group of transmit antennas, a group of transmit antenna ports, a component carrier, an eNodeB) and a terminal apparatus (a terminal, a mobile terminal, a receiving point, a reception terminal, a reception device, a group of receive antennas, a group of receive antenna ports, UE). In addition, a base station apparatus connected to a terminal apparatus (establishing a wireless link) is called a serving cell.

The base station apparatus and the terminal apparatus according to the present embodiment are capable of communicating in a frequency band called a licensed band for which a wireless carrier has received an approval of use (license) from a country or region where the wireless carrier provides services, and/or in a frequency band called an unlicensed band for which no approval of use (license) from a country or region is required.

According to the present embodiment, “X/Y” includes the meaning of “X or Y”. According to the present embodiment, “X/Y” includes the meaning of “X and Y”. According to the present embodiment, “X/Y” includes the meaning of “X and/or Y”.

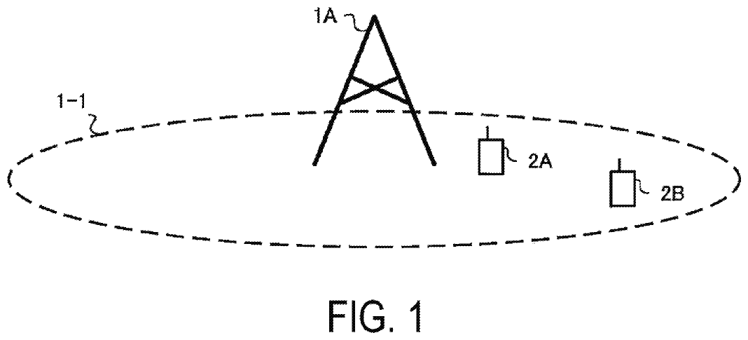

FIG. 1 is a diagram illustrating an example of a communication system according to the present embodiment. As illustrated in FIG. 1, the communication system according to the present embodiment includes a base station apparatus 1A and terminal apparatuses 2A and 2B. Coverage 1-1 is a coverage (a communication area) in which the base station apparatus 1A can connect to the terminal apparatuses. The terminal apparatuses 2A and 2B are also collectively referred to as a terminal apparatus 2.

In FIG. 1, the following uplink physical channels are used for uplink radio communication from the terminal apparatus 2A to the base station apparatus 1A. The uplink physical channels are used for transmission of information output from a higher layer.
Physical Uplink Control Channel (PUCCH)
Physical Uplink Shared Channel (PUSCH)
Physical Random Access Channel (PRACH)

The PUCCH is used for transmission of Uplink Control Information (UCI). Here, the Uplink Control Information includes a positive acknowledgement (ACK) or a negative acknowledgement (NACK), (ACK/NACK), for downlink data (a downlink transport block or a downlink-shared channel (DL-SCH)). ACK/NACK for the downlink data is also referred to as HARQ-ACK or HARQ feedback.

In addition, the Uplink Control Information includes channel state information (CSI) for the downlink. The Uplink Control Information includes a Scheduling Request (SR) used to request an uplink-shared channel (UL-SCH) resource. The Channel State Information refers to a Rank Indicator (RI) specifying a suitable spatial multiplexing number, a Precoding Matrix Indicator (PMI) specifying a suitable precoder, a Channel Quality Indicator (CQI) specifying a suitable transmission rate, a CSI-Reference Signal Resource Indication (CRI) indicating a suitable CSI-RS resource, and the like.

The Channel Quality Indicator (hereinafter, referred to as a CQI value) can be a suitable modulation scheme (e.g., QPSK, 16QAM, 64QAM, 256QAM, or the like) and a suitable coding rate in a predetermined band (details of which will be described later). The CQI value can be an index (CQI Index) determined by the above change scheme, coding rate, and the like. The CQI value can take a value determined beforehand in the system.

The Rank Indicator and the Precoding Quality Indicator can take the values determined beforehand in the system. Each of the Rank Indicator, the Precoding Matrix Indicator, and the like can be an index determined by the number of spatial multiplexing, Precoding Matrix information, or the like. Note that values of the Rank Indicator, the Precoding Matrix Indicator, and the Channel Quality Indicator are collectively referred to as CSI values.

PUSCH is used for transmission of uplink data (an uplink transport block, UL-SCH). Furthermore, PUSCH may be used for transmission of ACK/NACK and/or Channel State Information along with the uplink data. In addition, PUSCH may be used to transmit the Uplink Control Information only.

PUSCH is used to transmit an RRC message. The RRC message is a signal/information that is processed in a Radio Resource Control (RRC) layer. Further, PUSCH is used to transmit an MAC Control Element (CE). Here, MAC CE is a signal/information that is processed (transmitted) in a Medium Access Control (MAC) layer.

For example, a power headroom may be included in MAC CE and reported via PUSCH. In other words, a MAC CE field may be used to indicate a level of the power headroom.

The PRACH is used to transmit a random access preamble.

In the uplink radio communication, an UpLink Reference Signal (UL RS) is used as an uplink physical signal. The uplink physical signal is not used for transmission of information output from a higher layer, but is used by the physical layer. Here, the Uplink Reference Signal includes a demodulation reference signal (DMRS) and a sounding reference signal (SRS).

The DMRS is associated with transmission of the PUSCH or the PUCCH. For example, the base station apparatus 1A uses DMRS in order to perform channel compensation of PUSCH or PUCCH. The SRS is not associated with the transmission of the PUSCH or the PUCCH. For example, the base station apparatus 1A uses SRS to measure an uplink channel state.

In FIG. 1, the following downlink physical channels are used for the downlink radio communication from the base station apparatus 1A to the terminal apparatus 2A. The downlink physical channels are used for transmission of information output from a higher layer.
Physical broadcast channel (PBCH)
Physical control format indicator channel (PCFICH)
Physical hybrid automatic repeat request indicator channel (PHICH)
Physical downlink control channel (PDCCH)
Enhanced physical downlink control channel (EPDCCH)
Physical downlink shared channel (PDSCH)

PBCH is used for broadcasting a master information block (MIB, a broadcast channel (BCH)) that is commonly used by the terminal apparatuses. PCFICH is used for transmission of information indicating a region (e.g., the number of OFDM symbols) to be used for transmission of PDCCH.

PHICH is used for transmission of ACK/NACK with respect to uplink data (a transport block, a codeword) received by the base station apparatus 1A. In other words, PHICH is used for transmission of a HARQ indicator (HARQ feedback) indicating ACK/NACK with respect to the uplink data. Note that ACK/NACK is also called HARQ-ACK. The terminal apparatus 2A reports ACK/NACK received to a higher layer. ACK/NACK refers to ACK indicating a successful reception, NACK indicating an unsuccessful reception, and DTX indicating that no corresponding data is present. In a case that PHICH for uplink data is not present, the terminal apparatus 2A reports ACK to a higher layer.

The PDCCH and the EPDCCH are used for transmission of Downlink Control Information (DCI). Here, multiple DCI formats are defined for transmission of the downlink control information. In other words, a field for the downlink control information is defined in a DCI format and is mapped to information bits.

For example, as a DCI format for the downlink, DCI format 1A to be used for the scheduling of one PDSCH in one cell (transmission of a single downlink transport block) is defined.

For example, the DCI format for the downlink includes downlink control information such as information of PDSCH resource allocation, information of a Modulation and Coding Scheme (MCS) for PDSCH, a TPC command for PUCCH, and the like. Here, the DCI format for the downlink is also referred to as downlink grant (or downlink assignment).

Furthermore, for example, as a DCI format for the uplink, DCI format 0 to be used for the scheduling of one PUSCH in one cell (transmission of a single uplink transport block) is defined.

For example, the DCI format for the uplink includes uplink control information such as information of PUSCH resource allocation, information of MCS for PUSCH, a TPC command for PUSCH, and the like. The DCI format for the uplink is also referred to as uplink grant (or uplink assignment).

Further, the DCI format for uplink can be used for requesting (CSI request) Channel State Information (CSI) of a downlink that is also referred to as reception quality information.

The DCI format for the uplink can be used for a configuration indicating an uplink resource to which a CSI feedback report is mapped, the CSI feedback report being fed back to the base station apparatus by the terminal apparatus. For example, the CSI feedback report can be used for a configuration indicating an uplink resource for periodically reporting Channel State Information (periodic CSI). The CSI feedback report can be used for a mode configuration (CSI report mode) to periodically report the Channel State Information.

For example, the CSI feedback report can be used for a configuration indicating an uplink resource to report aperiodic Channel State Information (aperiodic CSI). The CS feedback report can be used for a mode configuration (CSI report mode) to aperiodically report the Channel State Information. The base station apparatus can configure any one of the periodic CSI feedback report and the aperiodic CSI feedback report. In addition, the base station apparatus can configure both the periodic CSI feedback report and the aperiodic CSI feedback report.

The DCI format for the uplink can be used for a configuration indicating a type of the CSI feedback report that is fed back to the base station apparatus by the terminal apparatus. The type of CSI feedback report includes wideband CSI (e.g., Wideband CQI), narrowband CSI (e.g., Subband CQI), and the like.

In a case where a PDSCH resource is scheduled based on the downlink assignment, the terminal apparatus receives downlink data on the scheduled PDSCH. In a case where a PUSCH resource is scheduled based on the uplink grant, the terminal apparatus transmits uplink data and/or uplink control information on the scheduled PUSCH.

PDSCH is used for transmission of downlink data (a downlink transport block, DL-SCH). In addition, PDSCH is used to transmit a system information block type 1 message. The system information block type 1 message is cell-specific information.

The PDSCH is used to transmit a system information message. The system information message includes a system information block X other than the system information block type 1. The system information message is cell-specific information.

In addition, PDSCH is used to transmit an RRC message. Here, the RRC message transmitted from the base station apparatus may be a common message to multiple terminal apparatuses in a cell. Further, the RRC message transmitted from the base station apparatus 1A may be a dedicated message to a given terminal apparatus 2 (also referred to as dedicated signaling). In other words, user-equipment-specific information (unique to user equipment) is transmitted using a message dedicated to the given terminal apparatus. PDSCH is used for transmission of MAC CE.

Here, the RRC message and/or MAC CE is also referred to as higher layer signaling.

PDSCH can be used to request downlink channel state information. PDSCH can be used for transmission of an uplink resource to which a CSI feedback report is mapped, the CST feedback report being fed back to the base station apparatus by the terminal apparatus. For example, the CSI feedback report can be used for a configuration indicating an uplink resource for periodically reporting Channel State Information (periodic CSI). The CSI feedback report can be used for a mode configuration (CSI report mode) to periodically report the channel state information.

The type of downlink CSI feedback report includes wideband CST (e.g., Wideband CS) and narrowband CSI (e.g., Subband CS). The wideband CSI calculates one piece of Channel State Information for the system band of a cell. The narrowband CSI divides the system band in predetermined units, and calculates one piece of Channel State Information for each division.

In the downlink radio communication, a Synchronization signal (SS) and a DownLink Reference Signal (DL RS) are used as downlink physical signals. The downlink physical signals are not used for transmission of information output from the higher layer, but are used by the physical layer.

The Synchronization signal is used for the terminal apparatus to take synchronization in the frequency domain and the time domain in the downlink. The Downlink Reference Signal is used for the terminal apparatus to perform channel compensation on a downlink physical channel. For example, the Downlink Reference Signal is used for the terminal apparatus to calculate the downlink Channel State Information.

Here, the Downlink Reference Signals include a Cell-specific Reference Signal (CRS), a UE-specific Reference Signal (URS) or a terminal apparatus-specific reference signal relating to PDSCH, a Demodulation Reference Signal (DMRS) relating to EPDCCH, a Non-Zero Power Chanel State Information-Reference Signal (NZP CSI-RS), and a Zero Power Chanel State Information-Reference Signal (ZP CSI-RS).

CRS is transmitted in all bands of a subframe and is used to perform demodulation of PBCH/PDCCH/PHICH/PCFICH/PDSCH. URS relating to PDSCH is transmitted in a subframe and a band that are used for transmission of PDSCH to which URS relates, and is used to demodulate PDSCH to which URS relates.

DMRS relating to EPDCCH is transmitted in a subframe and a band that are used for transmission of EPDCCH to which DMRS relates. DMRS is used to demodulate EPDCCH to which DMRS relates.

A resource for NZP CSI-RS is configured by the base station apparatus 1A. The terminal apparatus 2A performs signal measurement (channel measurement), using NZP CSI-RS. A resource for ZP CSI-RS is configured by the base station apparatus 1A. The base station apparatus 1A transmits ZP CSI-RS with zero output. The terminal apparatus 2A performs interference measurement in a resource to which NZP CSI-RS corresponds, for example.

A Multimedia Broadcast multicast service Single Frequency Network (MBSFN) RS is transmitted in all bands of the subframe used for transmitting PMCH. MBSFN RS is used to demodulate PMCH. PMCH is transmitted on the antenna port used for transmission of MBSFN RS.

Here, the downlink physical channel and the downlink physical signal are also collectively referred to as a downlink signal. The uplink physical channel and the uplink physical signal are also collectively referred to as an uplink signal. The downlink physical channels and the uplink physical channels are collectively referred to as physical channels. The downlink physical signals and the uplink physical signals are also collectively referred to as physical signals.

BCH, UL-SCH, and DL-SCH are transport channels. Channels used in the Medium Access Control (MAC) layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword and coding processing and the like is performed for each codeword.

Also, with respect to a terminal apparatus supporting carrier aggregation (CA), the base station apparatus can communicate by integrating a plurality of component carriers (CC) for broadband transmission. In carrier aggregation, one primary cell (PCell) and one or more secondary cells (SCell) are configured as a set of serving cells.

In dual connectivity (DC), a master cell group (MCG) and a secondary cell group (SCG) are configured as a group of serving cells. MCG consists of a PCell and optionally one or more SCells. Also, the SCG consists of a primary SCell (PSCell) and optionally one or more SCells.

The base station apparatus can transmit the CSI-RS configuration information to the terminal apparatus. The CSI-RS configuration information includes some or all of the number of antenna ports, the resource configuration, and the subframe configuration. The resource configuration is information on the resource to which the CSI-RS is mapped. The subframe configuration is information on the subframe to which the CSI-RS is mapped and the cycle at which the CSI-RS is transmitted.

In addition, for the CSI-RS, CLASS A (non-precoded) and/or CLASS B (beamformed) is configured as an eMIMO type (CSI report type) of the CSI report (feedback). Note that, the CSI-RS for which CLASS A (non-precoded) is configured is also referred to as a non-precoded CSI-RS (NP CSI-RS, first CSI-RS), and the CSI-RS for which CLASS B (beamformed) is configured is also referred to as (BF CSI-RS, second CSI-RS). The base station apparatus can also transmit information indicating whether the CSI-RS is NP CSI-RS or the CSI-RS is BF CSI-RS to the terminal apparatus. Namely, the terminal apparatus receives information indicating whether the CSI-RS is NP CSI-RS or the CSI-RS is BF CSI-RS from the base station apparatus and is able to know whether the configured CSI-RS is NP CSI-RS or BF CSI-RS. In addition, the NP-CSI-RS and/or the BF CSI-RS are used for CSI measurement, RRM (Radio Resource Manager) measurement, RLM (Radio Link Monitorink) measurement, and the like.

In addition, the base station apparatus can include, in a higher layer signaling, a configuration on a procedure to calculate the channel condition information (CSI Process), at least associating the CSI-RS for channel measurement with a CSI-IM (Interference Measurement). The CSI process can include some or all of, its CSI process ID, the CSI-RS configuration information, the CSI-RS configuration ID, information indicating whether the CSI-RS is a NP CSI-RS or a BF CSI-RS (eMIMO type, or CSI report type), the NP CSI-RS configuration information, and the BF CSI-RS configuration information. The base station apparatus can configure one or more CSI processes. The base station apparatus can independently generate CSI feedback for each of the CSI processes. The base station apparatus can configure the CSI-RS resource and the CSI-IM differently for each CSI process. One or more CSI processes are configured for a terminal apparatus, and a CSI report is independently performed for each configured CSI process. Also, the CSI process is configured in a predetermined transmission mode.

One CSI-RS resource is configured for a NP CSI-RS. Also, one CSI-RS resource can be configured with multiple CSI-RS resource configurations. The number of antenna ports for each of the multiple CSI-RS resources may be the same or different. For example, a 12-port CSI-RS resource is configured with three 4-port CSI-RS resources. Also, for example, a 16-port CSI-RS resource is configured with two 8-port CSI-RS resources. Also, for example, a 20-port CSI-RS resource is configured with 12 port CSI-RS resource configuration and 8 ports CSI-RS resources. Also, for example, a 24-port CSI-RS resource is configured with three 8-port CSI-RS resources or two 12-port CSI-RS resources. Also, for example, a 28-port CSI-RS resource is configured with a 12-port CSI-RS resource and a 16-port CSI-RS resource. Further, for example, a 32-port CSI-RS resource is configured with two 16-port CSI-RS resources or four 8-port CSI-RSs. Note that the configuration of the CSI-RS resource for each of the numbers of the antenna ports is an example, and not limited to thereto.

In addition, in a case that the CSI-RS configuration ID is configured, one CSI-RS configuration ID is configured in the NP CSI-RS. In addition, the base station apparatus can spread the NP CSI-RS with a plurality of spreading factors (spreading code lengths) to transmit the NP CSI-RS. Further, the base station apparatus can transmit, to the terminal apparatus, information indicating which spreading factor (spreading code length) has been used. Namely, the terminal apparatus can recognize the spreading factor (spreading code length) used for the NP CSI-RS based on the information, received from the base station apparatus, indicating which spreading factor (spreading code length) has been used.

The terminal apparatus according to the present embodiment can feed back CSI based on a plurality of feedback information formats. One of the plurality of feedback information formats is CSI feedback performed based on PMI/CQI/RI/CRI and the like, which is, hereinafter, also referred to as Implicit CSI feedback (implicit feedback information format) below. One of the plurality of feedback information formats is CSI feedback performed based on information obtained by directly quantizing channel state information between a terminal apparatus and a base station apparatus, which is, hereinafter, also referred to as Explicit CSI feedback (explicit feedback information format) below.

The information that the terminal apparatus feeds back to the base station apparatus by explicit CSI feedback includes, information obtained by directly quantizing information indicating the channel state information (channel state matrix, channel matrix), estimated by the terminal apparatus, between the terminal apparatus and the base station apparatus, information obtained by quantizing the information obtained, by the terminal apparatus, by applying a reversible process to the channel state information, information obtained by quantizing the information obtained by applying irreversible processing, and information obtained by quantizing the information indicating the discrepancy between the information the terminal apparatus has informed to the base station apparatus in the implicit CSI feedback and the actual channel state information. The reversible processing includes, eigenvalue decomposition, singular value decomposition, Givens rotation, FFT/IFFT processing, DFT/IDFT processing, and discrete cosine transformation/inverse discrete cosine transformation, of the channel state information. The information obtained by the reversible processing includes channel state information, channel state matrix information, eigenvectors, eigenvalues, singular values, and information indicating channel impulse response. The irreversible processing includes, for the channel state information, averaging processing, interpolation processing, extrapolation processing, window function processing, and convolution processing in any one or some of the time domain, the frequency domain, the spatial domain, and the code domain. The amount of information is suppressed (compressed) through reversible processing or irreversible processing. Further, the information the terminal apparatus feeds back to the base station apparatus by explicit CSI feedback includes, a reception quality information the terminal apparatus calculates assuming that there is no inter-cell interference, and a reception quality information the terminal apparatus calculates assuming that there is inter-cell interference included. The processing associated with the explicit CSI feedback can be explicitly configured in the terminal apparatus by the base station apparatus, or negotiated with the terminal apparatus by the base station apparatus in advance. The base station apparatus can implicitly configure the processing associated with the explicit CSI feedback for the terminal apparatus, by configuring, in the terminal apparatus, amount of information (feedback amount, size) of the CSI report the terminal apparatus performs by the explicit CSI feedback.

The base station apparatus can configure which of the plurality of feedback information formats to be used in the terminal apparatus. For example, the base station apparatus can describe information indicating which of the plurality of feedback information formats to be used in an aperiodic CS feedback trigger requesting aperiodic CSI feedback. Also, the base station apparatus can transmit, to the terminal apparatus, the CSI report type including the information indicating the feedback information format, and the CSI-RS configuration information ID which is the ID of the CSI-RS configuration information, as well as the information of the periodic CSI-RS or the information of the aperiodic CSI-RS. In addition, the base station apparatus can configure the plurality of feedback information formats for each CSI process and/or for each CSI subframe set and/or for a pair of CSI process and a CSI subframe set.

The base station apparatus can configure the CSI-RS for each of the plurality of feedback information formats for the terminal apparatus. The base station apparatus can configure different numbers of CSI-RS ports for each of the plurality of feedback information formats. For example, the base station apparatus can configure such that, in a case that 16 or less CSI-RS ports are configured the terminal apparatus performs implicit CSI feedback, and in a case that more than 16 CSI-RS ports are configured the terminal apparatus performs explicit CSI feedback. Also, the maximum number of antenna ports to which explicit CSI feedback is applicable can be configured.

The base station apparatus can associate a different amount of feedback information with each of the plurality of feedback information formats. The base station apparatus can configure a different feedback cycle for each of the plurality of feedback information formats. For example, in a case that the base station apparatus configures the feedback cycle of X ms for the implicit CSI feedback in the terminal apparatus, the base station apparatus can configure the feedback cycle of Y ms for the explicit CSI feedback in the terminal apparatus, and the base station apparatus allows X and Y to be configured to different values.

Further, the plurality of feedback information formats can selectively or simultaneously be configured in the terminal apparatus according to the DCI that the base station apparatus informs to the terminal apparatus, the DCI format, or content of description in the DCI format. For example, in a case that the base station apparatus configures a transmission mode of uplink transmission of the terminal apparatus by the DCI, and the transmission mode is not included in the predetermined transmission mode, the base station apparatus can configure the implicit CSI feedback for the terminal apparatus. Since the amount of CSI feedback information included in the signal transmitted by the terminal apparatus in the uplink transmission increases in the explicit CSI feedback, the base station apparatus can configure the explicit CSI feedback for the terminal apparatus in which the transmission mode capable of supporting (capable of transmitting) the amount of CSI feedback information can be configured. Alternatively, the base station apparatus can configure the explicit CSI feedback for the terminal apparatus in a case that information indicating that the terminal supports the explicit CSI feedback is received from the terminal apparatus as capability information of terminal.

The base station apparatus can simultaneously configure the plurality of feedback information formats for the terminal apparatus. For example, the base station apparatus can simultaneously configure feedback of the PMI as the implicit CSI feedback, and feedback of the eigenvector as the explicit CSI feedback, for the terminal apparatus. Further, for example, the base station apparatus can configure feedback of the PMI as the implicit CSI feedback, and simultaneously configure, as the explicit CSI feedback, linear filter (precoder) indicated by the PMI and feedback of information indicating the discrepancy of channel state information between the base station apparatus and the terminal apparatus. Note that, information indicating the discrepancy of the channel state information can also be fed back by the PMI or by joint coding with the PMI.

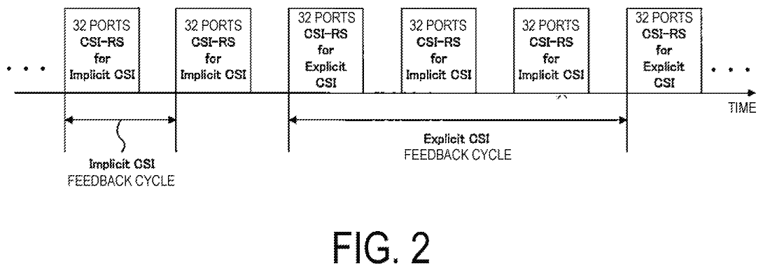

The base station apparatus can configure different feedback cycles (CSI report cycles) in a case that the base station apparatus simultaneously configures the plurality of the feedback information formats for the terminal apparatus. FIG. 2 is a schematic diagram illustrating the state of the CSI feedback cycle configured for each feedback information format according to the present embodiment. As illustrated in FIG. 2, the base station apparatus can configure the cycle of the explicit CSI feedback shorter than the cycle of the implicit CSI feedback cycle, for the terminal apparatus. By configuring in this way, an increase in overhead associated with the explicit CSI feedback can be avoided, since an interval for the feedback cycle of the explicit feedback with higher overhead associated with feedback is made longer. Also, the base station apparatus can configure the cycle of the explicit CSI feedback longer than the cycle of the implicit CSI feedback, for the terminal apparatus.

In the explicit CSI feedback, the base station apparatus can configure the plurality of CSI reports for the terminal apparatus. For example, in the explicit CSI feedback, the base station apparatus can simultaneously configure the longer-cycle CSI report and the shorter-cycle CSI report. The longer cycle CSI report is, for example, wideband CSI (wideband CSI report). Multiple pieces of channel state information that the terminal apparatus has estimated for CSI-RSs are averaged over the entire allocated bandwidth to generate the wideband CSI. The shorter cycle CSI report is, for example, subband CSI (subband CSI report). Multiple pieces of channel state information that the terminal apparatus has estimated for CSI-RSs are averaged for each RB or for each subband to generate the subband CSI.

In the explicit CSI feedback, the base station apparatus can configure two CSI reports, W1 and W2, for the terminal apparatus. In the explicit CSI feedback, W1 and W2 can respectively be channel matrices or eigenvectors. The base station apparatus can configure W1 as wideband CSI and W2 as subband CSI for the terminal apparatus. The base station apparatus can configure the report cycles of W1 and W2 to have different values for the terminal apparatus. For example, the base station apparatus can configure the report cycle of the W1 shorter than the report cycle of the W2.

In the explicit CSI feedback, the base station apparatus can divide W1 into the information associated with antennas arranged in the horizontal direction (for example, W1H) and the information associated with antennas arranged in the vertical direction (for example, W1V), and configure a CSI report on each information, for the terminal apparatus. The base station apparatus can configure explicit CSI feedback for the CSI-RS associated with the antennas arranged in the horizontal direction, and the CSI report associated with the CSI-RS, and configure implicit CSI feedback for the CSI-RS associated with the antennas arranged in the vertical direction, and the CSI report associated with the CSI-RS. In multiuser spatial multiplexing transmission in which simultaneous transmissions are performed to the plurality of terminal apparatuses, the transmission performances significantly change depending on the beam pattern the base station apparatus generates by the antennas arranged in the horizontal direction. The accuracy of the multiuser spatial multiplexing transmission by the base station apparatus is improved by performing the CSI report associated with the antennas arranged in the horizontal direction, in the explicit CSI feedback, from the terminal apparatus to the base station apparatus. Note that the base station apparatus can configure the implicit CSI feedback for the CSI-RS associated with the antennas arranged in the horizontal direction, and the CSI report associated with the CSI-RS, and can configure the explicit CSI feedback for the CSI-RS associated with the antennas arranged in the vertical direction, and the CSI report associated with the CSI-RS.

The base station apparatus can configure the explicit CSI feedback and the implicit CSI feedback for the W1, and the explicit CSI feedback and the implicit CSI feedback for the W2. For example, in a case that the base station apparatus configures the CSI report on W1 (or W2) for the terminal apparatus, the base station apparatus can configure the explicit CST feedback and the implicit CST feedback, and allows the report cycle at which the terminal apparatus reports W1 in the explicit CSI feedback and the report cycle at which the terminal apparatus reports W1 in the implicit CST feedback to have different values. In a case that at least two of the plurality of CSI reports are generated at the same time, the terminal apparatus may perform all the CSI reports or may preferentially perform one of the CSI reports.

The base station apparatus can configure W1 to be a CSI report by the implicit CSI feedback and W2 to be a CSI report by the explicit CST feedback for the terminal apparatus. In the environment where the terminal apparatus moves, since the fluctuation of W1 which is the wideband CSI is faster than the fluctuation of W2 which is the subband CSI, the accuracy of the beam forming of the base station apparatus is improved by accurately reporting W2 to the base station apparatus by the explicit CSI feedback.

The base station apparatus can configure W1 to be the CSI report by the explicit CSI feedback, and configure W2 to be the CSI report by the implicit CSI feedback, for the terminal apparatus. In multiuser spatial multiplexing transmission in which simultaneous transmissions are performed to the plurality of terminal apparatuses, the transmission performances significantly change depending on the beam pattern generated by the base station apparatus based on W1 which is the wideband CSI. By accurately reporting W1 to the base station apparatus by the explicit CSI feedback, the accuracy of multiuser spatial multiplexing transmission by the base station apparatus is improved.

The base station apparatus allows analog feedback to be included in the plurality of feedback information formats. The terminal apparatus can transmit, as analog feedback, the channel state information between the terminal apparatus and the base station apparatus that is estimated by the terminal apparatus to the base station apparatus as a transmission symbol.

Further, whether to configure analog feedback for the terminal apparatus can be determined according to the DCI that the base station apparatus informs to the terminal apparatus, the DCI format, or content of the description in the DCI format. For example, in a case that the base station apparatus configures the transmission mode of the uplink transmission of the terminal apparatus by the DCI, and the transmission mode is not included in the predetermined transmission mode, the base station apparatus does not configure analog feedback for the terminal apparatus. Since an amount of CSI feedback information included in the signal transmitted by the terminal apparatus in the uplink transmission is increased in the analog feedback, the base station apparatus can configure analog feedback for a terminal apparatus that can configure a transmission mode capable of supporting (capable of transmitting) the amount of CSI feedback information. Note that, the terminal apparatus can transmit, to the base station, information on whether the terminal apparatus supports analog feedback as capability information of terminal.

Further, the base station apparatus can configure the radio resource through which the terminal apparatus performs analog feedback. The base station apparatus can configure analog feedback to be performed through, for example, a resource that transmits the SRS (SRS resource), a resource that transmits the DMRS (DMRS resource), a resource that transmits the PUSCH (PUSCH resource), or a resource that transmits the PUCCH (PUCCH resource). The uplink resources that the base station apparatus configures, for analog feedback, for the terminal apparatus, may be all or a part of the resources concerned. For example, for the terminal apparatus, the base station apparatus may configure all of the PUSCH resources to perform analog feedback, or may configure only a part of the PUSCH resources to perform analog feedback.

The base station apparatus allow the SRS trigger for requesting the terminal apparatus to transmit the SRS to include information indicating whether to configure the analog feedback. In addition, the base station apparatus can inform the terminal apparatus of whether the SRS trigger requests the analog feedback by the upper layer signaling such as the RRC signaling. This also applies to a case where the terminal apparatus performs analog feedback through another uplink resource.

The base station apparatus can configure the cycle at which the terminal apparatus performs analog feedback. At this time, in a case that the terminal apparatus performs the analog feedback based on the SRS resource, the SRS transmission cycle may coincide with the analog feedback cycle. At this time, the terminal apparatus may prioritize the transmission of the SRS or the analog feedback. The base station apparatus can configure the terminal apparatus to prioritize which one of the SRS transmission or the analog feedback by the upper layer signaling such as the RRC signaling.

In a case that the terminal apparatus performs analog feedback, the channel state information transmitted to the base station apparatus can have a constant amplitude at least when the information is transmitted within the same SC-FDMA symbols. Further, in a case that the terminal apparatus performs analog feedback through a part of the resources of the uplink transmission, the terminal apparatus can equalize the amplitude of the channel state information to be transmitted to the base station apparatus with the amplitude of the signal being transmitted through another resource. For example, in a case that the terminal apparatus performs analog feedback through a part of the SRS resources, the terminal apparatus can equalize the amplitude of the SRS being transmitted through another SRS resource with the amplitude of the signal being transmitted as analog feedback.

In a case that the terminal apparatus performs analog feedback, the amount of feedback information may be changed in accordance with the rank number of the terminal apparatus (or information indicated by RI), and the base station apparatus can configure the terminal apparatus in this manner. For example, the terminal apparatus may change the amount of feedback information between the case of informing the channel state information of rank 1 and the case of informing the channel state information of rank 2.

Further, in a case that analog feedback is performed, the terminal apparatus can transmit a plurality of pieces of channel state information by spreading them with a spreading code and/or multiplexing them.

Also, the base station apparatus can transmit a reference signal for analog feedback. The mapping of the reference signal for the analog feedback may be common in the cell or may be specific to a terminal apparatus. In this case, the terminal apparatus presumes the channel information from the reference signal for analog feedback received from the base station apparatus.

Further, in a case of spreading the NP CSI-RS, the base station apparatus can configure the OFDM symbol for spreading one NP CSI-RS and the sub-carrier interval to different values based on the number of ports of the CSI-RS. For example, in a case that the number of ports of the CSI-RS is equal to or smaller than a predetermined value (for example, 16), the base station apparatus can configure such that the plurality of OFDM symbols to spread one NP CSI-RS are included in one slot, and in a case that the number of ports of the CSI-RS exceeds a predetermined value, the plurality of OFDM symbols to spread one NP CSI-RS are included in two slots.

Further, the base station apparatus can configure the CSI-RS resource over the plurality of subframes. For example, in a case of configuring a 20-port CSI resources, the base station apparatus can configure a 12-port CSI-RS resource for the mth subframe, and a 8-port CSI-RS resource for the (m+1) th subframe, where m is a natural number. Namely, in a case of configuring the plurality of CSI-RS ports for a terminal apparatus, the base station apparatus according to the present embodiment can configure the plurality of subframes as subframes for configuring the CSI-RS ports.

In the case that the base station apparatus configures the CSI-RS resource over the plurality of subframes, a configuration cycle (CSI-RS resource transmission cycle, a CSI-RS resource configuration cycle) can be different for each subframe, or can be the same for the plurality of subframes.

In addition, the base station apparatus can map signals other than the CSI-RS to at least one CSI-RS resource among the plurality of CSI-RS resources configured for the terminal apparatus. The base station apparatus can configure, for the terminal apparatus, configuration information (CSI-RS subset restriction information) indicating the CSI-RS resource to which the signal other than the CSI-RS is mapped. The cycle at which the base station apparatus configures the CSI-RS subset restriction information for the terminal apparatus may be the same as or different from the cycle at which the base station apparatus configures the CSI-RS resource for the terminal apparatus.

In a case that the NP CSI-RS is configured, the base station apparatus can transmit the configuration information of the NP CSI-RS to the terminal apparatus. The configuration information of the NP CSI-RS includes some or all of the number of antenna ports, information on the Codebook Subset Restriction (CBSR), information on the codebook, an interference measurement limit which configures whether to limit a resource in a case of measuring interference,

one or more resource configurations, and the spreading code length. It should be noted that the base station apparatus can configure the number of antenna ports and the resource configuration that are associated with each other. For example, in a case that the configuration information of the NP CSI-RS includes the plurality of antenna ports and a plurality of configurations for at least one resource, the numbers of the antenna ports are associated with the plurality of configurations for the at least one resource.

In a case of transmitting the CSI-RS with a large number of antenna ports, resources for transmitting the CSI-RS are increased. Therefore, throughput is improved by reducing the overhead of the CSI-RS transmission. In order to reduce the overhead of the CSI-RS transmission, it is conceivable to increase the interval for the transmission cycle of the CSI-RS. For example, in horizontal beamforming and vertical beamforming, a suitable vertical beam typically changes more gradually than a suitable horizontal beam. Therefore, the overhead of the CSI-RS transmission can be reduced by increasing the interval for the transmission cycle of the CSI-RS related to the vertical beam. For example, 8 antenna ports in the horizontal direction and 4 antenna ports in the vertical direction result in the total of 32 antenna ports. In this case, the base station apparatus can transmit the 8-port CSI-RS in the horizontal direction at the cycle TH and the 32 port CSI-RS at the cycle TV. Here, TH is less than TV. Also, the 8-port CSI-RS configuration information may be included in the 32-port CSI-RS configuration information, or the 8-port CSI-RS configuration information and the 32-port CSI-RS configuration information may be configured separately. In a case that the 8-port CSI-RS configuration information and the 32-port CSI-RS configuration information are configured separately, the two sets of configuration information need to be linked. For example, the CSI-RS configuration ID included in the 8-port CSI-RS configuration information and the CSI-RS configuration ID included in the 32-port CSI-RS configuration information can be the same. In this case, the terminal apparatus can calculate and report the CSI in consideration of the CSI of the same CSI-RS configuration ID. Also, the ID of the reference target can be included in the 8 port or 32 port CSI-RS configuration information. At this time, the terminal apparatus can calculate and report the CSI in consideration of the CSI of the reference target ID. As described above, since the base station apparatus transmits the 8-port CSI-RS, or the 32-port CSI-RS, even in a case that the 32-port CSI-RS is configured, the overhead of CSI-RS can be reduced compared to the case of transmitting 32 port CSI-RS continuously. Also, the base station apparatus can include the transmission cycle of the CSI-RS in the configuration information of the NP CSI-RS. Further, in a case that the 32 port CSI-RS is configured, for example, the terminal apparatus can determine (identify) whether the 8 port CSI-RS has been transmitted or the 32 port CSI-RS has been transmitted, based on the configuration information of the CSI-RS and/or NP CSI-RS received from the base station apparatus. Further, in a case that the 32 port CSI-RS is configured and the 8 port CSI-RS is received, the terminal apparatus can calculate the CQI/PMI/RI from the 8-port CSI-RS and report it to the base station apparatus, or the terminal apparatus can calculate the CQI/PMI/RI of 8 ports using the 32 port CQI/PMI/RI calculated at the previous report and report it to the base station apparatus.

Also, the base station apparatus can configure a longer interval for the transmission cycle of the CSI-RS in the case of a large number of antenna ports. Namely, it is possible to change the configurable transmission cycle of CSI-RS depending on the number of antenna ports. For example, a case that the number of antenna ports is greater than 16 configures a longer interval for the cycle than a case that the number of antenna ports is 16 or less. Further, for example, in a case that the number of antenna ports of the CSI-RS is greater than 16, the base station apparatus can include the transmission cycle of the CSI-RS in the CSI-RS configuration information or the NP CSI-RS configuration information.

One or more CSI-RS resources are configured in the BF CSI-RS. Here, the number of CSI-RS resources is assumed to be K. Beamforming is performed such that at least one of the plurality of CSI-RSs has a different beam direction. Also, the maximum number of antenna ports of the BF CSI-RS is smaller than the maximum number of antenna ports of the NP CSI-RS. In addition, in a case that the CSI-RS ID is configured, at least one of the plurality of CSI-RS IDs is configured in the BF CSI-RS. Further, in a case that the BF CSI-RS is configured, the terminal apparatus selects a suitable CSI-RS resource from the plurality of CSI-RS resources and reports the CQI/PMI/RI/CRI as the CSI to the base station apparatus.

In a case that the BF CSI-RS is configured, the base station apparatus can transmit the configuration information of the BF CSI-RS to the terminal apparatus. The configuration information of the BF CSI-RS includes one or some of, at least one of the plurality of CSI-RS configuration IDs, an interference measurement limit, information on codebook subset restriction (CBSR), indication of different code books in 4 ports for each CSI-RS configuration ID, information on the BF CSI-RS code book, and a channel measurement limit which configures whether to limit resources (subframes) at the time of channel measurement.

The base station apparatus can obtain the channel information of the terminal apparatus by the CSI report from the terminal apparatus. The terminal apparatus can report the CQI/PMI/RI to the base station apparatus in a case that the NP CSI-RS (CLASS A) is configured. The CQI/PMI/RI/CRI can be reported to the base station apparatus in a case that BF CSI-RS (CLASS B) is configured. Also, in a case that both the NP CSI-RS and the BF CSI-RS are configured (also referred to as CLASS C), the terminal apparatus reports the CSI on the NP CSI-RS and the CSI on the BF CSI-RS.

The base station apparatus can configure the implicit CSI feedback for the terminal apparatus for which the NP CSI-RS (CLASS A) is configured. Also, the base station apparatus can configure the explicit CSI feedback, or both the implicit CSI feedback and the explicit CSI feedback, for the terminal apparatus for which the BF CSI-RS (CLASS B) is configured.

The terminal apparatus can report the CQI/PMI/RI to the base station apparatus based on the implicit CSI feedback, in a case that the NP CSI-RS (CLASS A) is configured. In a case that the BF CSI-RS (CLASS B) is configured, the terminal apparatus can report the eigenvector, for example, to the base station apparatus based on the explicit CSI feedback. Note that the terminal apparatus for which the BF CSI-RS (CLASS B) is configured can further report the CQI/PMI/RI/CRI.

Further, in a case that both the NP CSI-RS and the BF CSI-RS are configured, the base station apparatus can change the transmission cycle of the NP CSI-RS and the transmission cycle of the BF CSI-RS. For example, the base station apparatus can configure a longer interval for the transmission cycle of the NP CSI-RS than an interval for the transmission cycle of the BF CSI-RS.

In a case that the BF CSI-RS is configured, the base station apparatus can change the transmission cycle of the BF CSI-RS depending on which of the implicit CSI feedback or the explicit CSI feedback has been configured for the terminal apparatus. This also applies to the case where the NP CSI-RS is configured, or where both the NP CSI-RS and the BF CSI-RS are configured.

Also, the base station apparatus can configure the plurality of BF CSI-RSs having different K values. Also, the base station apparatus can change the transmission cycle of the CSI-RS according to the value of K. Since the overhead of the CSI-RS increases as the value of K increases, the overhead of the CSI-RS can be reduced by increasing the interval for the CSI-RS transmission cycle as the value of K is increased. For example, in a case that the BF CSI-RS with K=1 and the BF CSI-RS with K>1 are configured, an interval for the transmission cycle of the BF CSI-RS with K=1 can be shorter than an interval for the transmission cycle of the BF CSI-RS with K>1.

The base station apparatus can change the configuration of the feedback information format according to the value of K. For example, only in a case that K=1, the base station apparatus can configure the explicit feedback information format for the terminal apparatus, and in a case that K>1, the base station apparatus can configure the implicit feedback information format for the terminal apparatus.

Also, in a case that the plurality of BF CSI-RSs having different K values are configured, the terminal apparatus reports the CQI/PMI/RI/CRI for each of the configured BF CSI-RSs to the base station apparatus. Alternatively, the terminal apparatus selects a suitable BF CSI-RS resource from all of the configured BF CSI-RS resources and reports the CQI/PMI/RI/CRI of the BF CSI-RS to the base station apparatus.

The CSI-RS can be transmitted periodically. In addition, the CSI-RS can be transmitted aperiodically. The CSI-RS transmitted periodically is also referred to as periodic CSI-RS (P-CSI-RS), and the CSI-RS transmitted aperiodically is also referred to as aperiodic CSI-RS (A-CSI-RS). For example, the A-CSI-RS is transmitted at the timing indicated by the base station apparatus. In this case, the terminal apparatus receives the A-CSI-RS at the timing indicated by the base station apparatus in the control information, and the like. The configuration information of the P-CSI-RS and/or the configuration information of the A-CSI-RS are transmitted by the upper layer signaling or the physical layer signaling such as the downlink control information. The configuration information of the A-CSI-RS includes some or all of, the number of antenna ports, the CSI-RS configuration ID, the resource configuration, the CSI report type, and subframes (resources) for reporting the CSI. Further, the configuration information of the P-CSI-RS and/or the configuration information of the A-CSI-RS can be included in the configuration information of the CSI-RS. In a case that the base station apparatus transmits information on the A-CSI-RS included in the downlink control information, the base station apparatus transmits the CSI-RS in the same subframe (slot) as the downlink control information. Stated conversely, in a case that the received downlink control information includes information on the A-CSI-RS, the terminal apparatus receives the A-CSI-RS in the same subframe (slot) as the downlink control information. In this way, since the A-CSI-RS is transmitted at a certain timing and the CSI-RS is not transmitted when not necessary, the overhead of the CSI-RS can be reduced.

The base station apparatus can change the configuration of the feedback information format depending on whether the CSI-RS is transmitted periodically or aperiodically. For example, in a case of periodically transmitting the CSI-RS, the base station apparatus can configure the implicit feedback information format, and in a case of aperiodically transmitting the CSI-RS, the base station apparatus can configure the explicit feedback information format.

Also, in a case that a P-CSI-RS collides with an A-CSI-RS, the terminal apparatus prioritizes the A-CSI-RS to report CSI and the like. In a case that the NP CSI-RS is configured as the P-CSI-RS, and the BF CSI-RS is received as the A-CSI-RS, the terminal apparatus reports the CSI on the BF CSI-RS. Conversely, in a case that the BF CSI-RS is configured as the P-CSI-RS, and the NP CSI-RS is received as the A-CSI-RS, the terminal apparatus reports the CSI on the NP CSI-RS.

Also, the initial value for generating the P-CSI-RS sequence and the initial value for generating the A-CSI-RS sequence can be different. For example, the initial value of the P-CSI-RS sequence may be a physical cell ID, and the A-CSI-RS may be a user-specific ID. In this case, the terminal apparatus can determine whether the received CSI-RS is the P-CSI-RS or the A-CSI-RS by recognizing the initial value of the CSI-RS sequence.

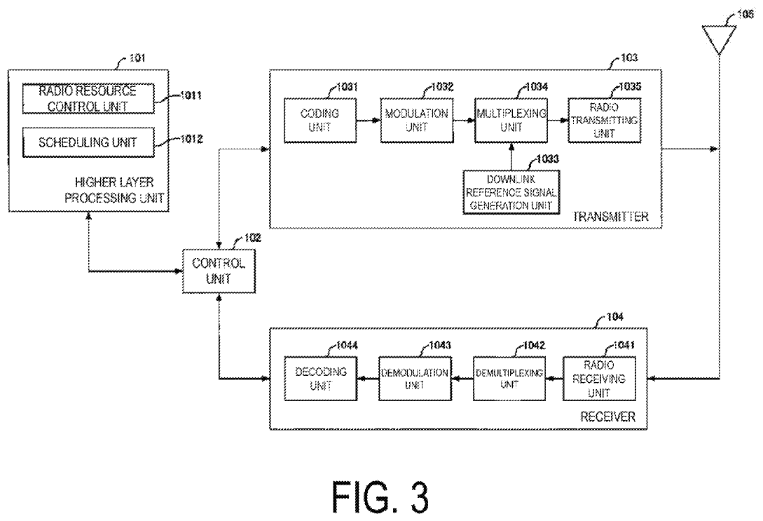

FIG. 3 is a schematic block diagram illustrating a configuration of the base station apparatus 1A according to the present embodiment. As illustrated in FIG. 3, the base station apparatus 1A is configured to include a higher layer processing unit (higher layer processing step) 101, a control unit (controlling step) 102, a transmitter (transmitting step) 103, a receiver (receiving step) 104, and a transmit and/or receive antenna 105. The higher layer processing unit 101 is configured to include a radio resource control unit (radio resource controlling step) 1011 and a scheduling unit (scheduling step) 1012. The transmitter 103 is configured to include a coding unit (coding step) 1031, a modulation unit (modulating step) 1032, a downlink reference signal generation unit (downlink reference signal generating step) 1033, a multiplexing unit (multiplexing step) 1034, and a radio transmitting unit (radio transmitting step) 1035. The receiver 104 is configured to include a radio receiving unit (radio receiving step) 1041, a demultiplexing unit (demultiplexing step) 1042, a demodulation unit (demodulating step) 1043, and a decoding unit (decoding step) 1044.

The higher layer processing unit 101 performs processing of the Medium Access Control (MAC) layer, a Packet Data Convergence Protocol (PDCP) layer, a Radio Link Control (RLC) layer, and the Radio Resource Control (RRC) layer. Furthermore, the higher layer processing unit 101 generates information necessary for controlling the transmitter 103 and the receiver 104, and outputs to the control unit 102.

The higher layer processing unit 101 receives, from the terminal apparatus, information on the terminal apparatus, such as the functions of the terminal apparatus (UE capability) and the like. To rephrase, the terminal apparatus transmits its own functions to the base station apparatus by higher layer signaling.

Note that in the following description, information on the terminal apparatus includes information indicating whether the terminal apparatus supports prescribed functions, or information indicating that the terminal apparatus has completed the introduction and test of prescribed functions. Note that in the following description, whether to support the prescribed functions includes whether the introduction and test of the prescribed functions have been completed.

For example, in a case that the terminal apparatus supports prescribed functions, the terminal apparatus transmits information (parameters) indicating whether to support the prescribed functions. In a case that the terminal apparatus does not support a prescribed function, the terminal apparatus does not transmit information (parameters) indicating whether to support the prescribed function. In other words, whether the prescribed function is supported is reported by whether to transmit the information (parameters) indicating whether the prescribed function is supported. Note that, information (parameters) indicating whether to support a prescribed function may be reported using one bit of 1 or 0.

The radio resource control unit 1011 generates, or acquires from a higher node, the downlink data (the transport block) allocated in the downlink PDSCH, system information, the RRC message, the MAC Control Element (CE), and the like. The radio resource control unit 1011 outputs the downlink data to the transmitter 103, and outputs other information to the control unit 102. Furthermore, the radio resource control unit 1011 manages various configuration information of the terminal apparatus.

The scheduling unit 1012 determines a frequency and a subframe to which the physical channels (PDSCH and PUSCH) are allocated, the coding rate and modulation scheme (or MCS) for the physical channels (PDSCH and PUSCH), the transmit power, and the like. The scheduling unit 1012 outputs the determined information to the control unit 102.

The scheduling unit 1012 generates the information to be used for the scheduling of the physical channels (PDSCH and PUSCH), based on the result of the scheduling. The scheduling unit 1012 outputs the generated information to the control unit 102.

The control unit 102 generates a control signal for controlling the transmitter 103 and the receiver 104 based on the information input from the higher layer processing unit 101. The control unit 102 generates the downlink control information based on the information input from the higher layer processing unit 101, and outputs to the transmitter 103.

The transmitter 103 generates the downlink reference signal in accordance with the control signal input from the control unit 102, codes and modulates the HARQ indicator, the downlink control information, and the downlink data that are input from the higher layer processing unit 101, multiplexes the PHICH, the PDCCH, the EPDCCH, the PDSCH, and the downlink reference signal, and transmits the signal to the terminal apparatus 2 through the transmit and/or receive antenna 105.

The coding unit 1031 codes the HARQ indicator, the downlink control information, and the downlink data that are input from the higher layer processing unit 101, in compliance with the coding scheme prescribed in advance, such as block coding, convolutional coding, or turbo coding, or in compliance with the coding scheme determined by the radio resource control unit 1011. The modulation unit 1032 modulates the coded bits input from the coding unit 1031, in compliance with the modulation scheme prescribed in advance, such as Binary Phase Shift Keying (BPSK), Quadrature Phase Shift Keying (QPSK), Quadrature Amplitude Modulation (16QAM), 64QAM, and 256QAM, or in compliance with the modulation scheme determined by the radio resource control unit 1011.

The downlink reference signal generation unit 1033 generates, as the downlink reference signal, a sequence known to the terminal apparatus 2A that can be acquired in accordance with a rule prescribed in advance based on the physical cell identifiers (PCI, cell ID) and the like for identifying the base station apparatus 1A.

The multiplexing unit 1034 multiplexes the modulated modulation symbol of each channel, the generated downlink reference signal, and the downlink control information. Namely, the multiplexing unit 1034 maps the modulated modulation symbol of each channel, the generated downlink reference signal, and the downlink control information to the resource elements.

The radio transmitting unit 1035 performs Inverse Fast Fourier Transform (IFFT) on the multiplexed modulation symbol or the like to generate an OFDM symbol, attaches a Cyclic Prefix (CP) to the OFDM symbol to generate a baseband digital signal, converts the baseband digital signal to an analog signal, removes unnecessary frequency components through filtering, performs up-conversion into a signal of a carrier frequency, performs power amplification, and performs output to the transmit and/or receive antenna 105 for transmission.

In accordance with the control signal input from the control unit 102, the receiver 104 demultiplexes, demodulates, and decodes the reception signal received from the terminal apparatus 2A through the transmit and/or receive antenna 105, and outputs the decoded information to the higher layer processing unit 101.

The radio receiving unit 1041 converts, by down-converting, an uplink signal received through the transmit and/or receive antenna 105 into a baseband signal, removes unnecessary frequency components, controls the amplification level in such a manner as to suitably maintain a signal level, performs orthogonal demodulation based on an in-phase component and an orthogonal component of the received signal, and converts the resulting orthogonally-demodulated analog signal into a digital signal.

The radio receiving unit 1041 removes a portion corresponding to a CP from the digital signal resulting from the conversion. The radio receiving unit 1041 performs Fast Fourier Transform (FFT) on the signal from which CP has been removed, extracts a signal in the frequency domain, and outputs the resulting signal to the demultiplexing unit 1042.

The demultiplexing unit 1042 demultiplexes the signal input from the radio receiving unit 1041 into the signal such as the PUCCH, the PUSCH, and the uplink reference signal. The demultiplexing is performed based on radio resource allocation information that is determined in advance by the radio resource control unit 1011 of the base station apparatus 1A and that is included in the uplink grant informed to each of the terminal apparatuses 2.

Furthermore, the demultiplexing unit 1042 performs a compensation of channel for PUCCH and PUSCH. The demultiplexing unit 1042 demultiplexes the uplink reference signal.

The demodulation unit 1043 performs Inverse Discrete Fourier Transform (IDFT) on PUSCH, acquires modulation symbols, and

performs reception signal demodulation with respect to each of the modulation symbols of PUCCH and PUSCH in compliance with the modulation scheme prescribed in advance, such as BPSK, QPSK, 16QAM, 64QAM, and 256QAM, or in compliance with the modulation scheme that the base station apparatus itself has informed in advance, with the uplink grant, to each of the terminal apparatuses 2.

The decoding unit 1044 decodes the coded bits of PUCCH and PUSCH, which have been demodulated, in compliance with a coding scheme prescribed in advance, and at the coding rate prescribed in advance or informed in advance with the uplink grant to the terminal apparatus 2 by the base station apparatus itself, and outputs the decoded uplink data and the uplink control information to the higher layer processing unit 101. In a case of a re-transmission on the PUSCH, the decoding unit 1044 performs the decoding with the coded bits input from the higher layer processing unit 101 and retained in an HARQ buffer, and the demodulated coded bits.

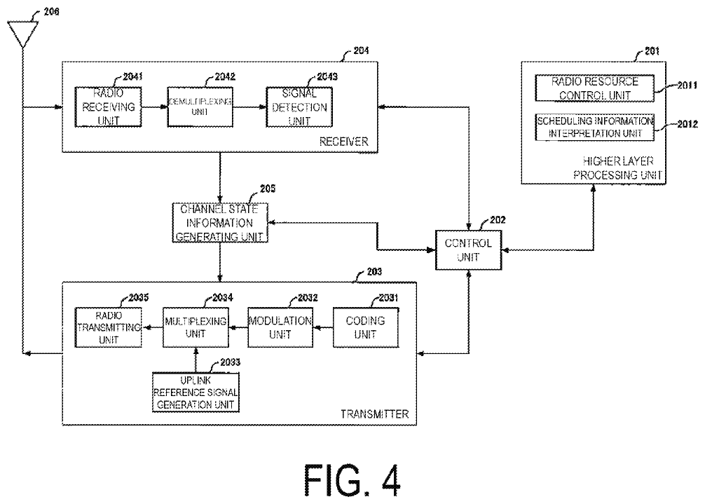

FIG. 4 is a schematic block diagram illustrating a configuration of the terminal apparatus 2 according to the present embodiment. As illustrated in FIG. 4, the terminal apparatus 2A is configured to include a higher layer processing unit (higher layer processing step) 201, a control unit (controlling step) 202, a transmitter (transmitting step) 203, a receiver (receiving step) 204, a channel state information generating unit (channel state information generating step) 205, and a transmit and/or receive antenna 206. The higher layer processing unit 201 is configured to include a radio resource control unit (radio resource controlling step) 2011 and a scheduling information interpretation unit (scheduling information interpreting step) 2012. The transmitter 203 is configured to include a coding unit (coding step) 2031, a modulation unit (modulating step) 2032, an uplink reference signal generation unit (uplink reference signal generating step) 2033, a multiplexing unit (multiplexing step) 2034, and a radio transmitting unit (radio transmitting step) 2035. The receiver 204 is configured to include a radio receiving unit (radio receiving step) 2041, a demultiplexing unit (demultiplexing step) 2042, and a signal detection unit (signal detecting step) 2043.

The higher layer processing unit 201 outputs the uplink data (the transport block) generated by a user operation and the like, to the transmitter 203. The higher layer processing unit 201 performs processing of the Medium Access Control (MAC) layer, the Packet Data Convergence Protocol (PDCP) layer, the Radio Link Control (RLC) layer, and the Radio Resource Control (RRC) layer.

The higher layer processing unit 201 outputs, to the transmitter 203, information indicating functions of the terminal apparatus supported by the terminal apparatus itself.

The radio resource control unit 2011 manages various configuration information of the terminal apparatus itself. Furthermore, the radio resource control unit 2011 generates information to be mapped to each uplink channel, and outputs the generated information to the transmitter 203.

The radio resource control unit 2011 acquires configuration information of CSI feedback transmitted from the base station apparatus, and outputs the acquired information to the control unit 202.

The scheduling information interpretation unit 2012 interprets the downlink control information received through the receiver 204, and determines the scheduling information. The scheduling information interpretation unit 2012 generates the control information in order to control the receiver 204 and the transmitter 203 in accordance with the scheduling information, and outputs the generated information to the control unit 202.

The control unit 202 generates a control signal for controlling the receiver 204, the channel state information generating unit 205, and the transmitter 203, based on the information input from the higher layer processing unit 201. The control unit 202 outputs the generated control signal to the receiver 204, the channel state information generating unit 205, and the transmitter 203, to control the receiver 204 and the transmitter 203.

The control unit 202 controls the transmitter 203 to cause the CSI generated by the channel state information generating unit 205 to be transmitted to the base station apparatus.

The receiver 204 demultiplexes, demodulates, and decodes a reception signal received from the base station apparatus 1A through the transmit and/or receive antenna 206, and outputs the decoded information to the higher layer processing unit 201, in accordance with the control signal input from the control unit 202.

The radio receiving unit 2041 converts, by down-converting, a downlink signal received through the transmit and/or receive antenna 206 into a baseband signal, removes unnecessary frequency components, controls an amplification level in such a manner as to suitably maintain a signal level, performs orthogonal demodulation based on an in-phase component and an orthogonal component of the received signal, and converts the resulting orthogonally-demodulated analog signal into a digital signal.

In addition, the radio receiving unit 2041 removes a portion corresponding to a CP from the converted digital signal, performs fast Fourier transform on the signal from which a CP has been removed, and extracts a signal in the frequency domain.

The demultiplexing unit 2042 demultiplexes the extracted signal into the PHICH, the PDCCH, the EPDCCH, the PDSCH, and the downlink reference signal. Further, the demultiplexing unit 2042 performs a compensation of channel for the PHICH, the PDCCH, and the EPDCCH based on a channel estimation value of the desired signal obtained from the channel measurement, detects the downlink control information, and outputs the detected information to the control unit 202. The control unit 202 outputs the PDSCH and the channel estimation value of the desired signal to the signal detection unit 2043.

The signal detection unit 2043, using the PDSCH and the channel estimation value, detects a signal, and outputs the detected signal to the higher layer processing unit 201.

The transmitter 203 generates the uplink reference signal in accordance with the control signal input from the control unit 202, codes and modulates the uplink data (the transport block) input from the higher layer processing unit 201, multiplexes the PUCCH, the PUSCH, and the generated uplink reference signal, and performs transmission to the base station apparatus 1A through the transmit and/or receive antenna 206.

The coding unit 2031 performs a coding processing such as convolutional coding and block coding of the uplink control information input from the higher layer processing unit 201. Furthermore, the coding unit 2031 performs a turbo coding based on information used for the scheduling of PUSCH.

The modulation unit 2032 modulates coded bits input from the coding unit 2031, in compliance with the modulation scheme informed in the downlink control information, such as BPSK, QPSK, 16QAM, and 64QAM, or in compliance with a modulation scheme prescribed in advance for each channel.

The uplink reference signal generation unit 2033 generates a sequence obtainable according to a rule (formula) prescribed in advance, based on a physical cell identifier (PCI, also referred to as a cell ID, or the like) for identifying the base station apparatus 1A, a bandwidth to which the uplink reference signal is mapped, a cyclic shift informed in the uplink grant, a parameter value for generation of a DMRS sequence, and the like.

The multiplexing unit 2034 performs Discrete Fourier Transform (DFT) after rearranging the modulation symbols of the PUSCH in parallel in accordance with the control signal input from the control unit 202. The multiplexing unit 2034 multiplexes the PUCCH signal, the PUSCH signal, and the generated uplink reference signal for each transmit antenna port. Namely, the multiplexing unit 2034 maps the PUCCH signal, the PUSCH signal, and the generated uplink reference signal to the resource element for each transmit antenna port.

The radio transmitting unit 2035 performs Inverse Fast Fourier Transform (IFFT) on the multiplexed signal, performing the modulation of SC-FDMA scheme, generates an SC-FDMA symbol, attaches a CP to the generated SC-FDMA symbol, generates a baseband digital signal, converts the baseband digital signal into an analog signal, removes unnecessary frequency components, performs up-conversion into a signal of a carrier frequency, performs power amplification, and performs output to the transmit and/or receive antenna 206 for transmission.

A program running on an apparatus according to the present invention may be a program that controls a Central Processing Unit (CPU) and the like to cause a computer to operate in such a manner as to realize the functions of the above-described embodiment according to the present invention. The program or information handled by the program are temporarily read into a volatile memory, such as a Random Access Memory (RAM) while being processed, or stored in a non-volatile memory, such as a flash memory and a Hard Disk Drive (HDD), and then read by the CPU to be modified or rewritten, as necessary.

Note that a part of the apparatus in the above-described embodiment may be realized by a computer. In that case, a program for realizing the functions of the embodiments may be recorded on a computer readable recording medium. This may be implemented by causing a computer system to read and perform a program recorded on this recording medium. It is assumed that the “computer system” mentioned here refers to a computer system built into the apparatus, and the computer system includes an operating system and hardware components such as a peripheral device. Furthermore, the “computer-readable recording medium” may be any of a semiconductor recording medium, an optical recording medium, a magnetic recording medium, and the like.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, each functional block or various characteristics of the apparatus used in the above-described embodiment may be mounted or performed on an electric circuit, namely, typically an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor, a conventional processor, a controller, a micro-controller, or a state machine. The above-mentioned electric circuit may be constituted of a digital circuit, or may be constituted of an analog circuit. Furthermore, in a case that with advances in semiconductor technology, a circuit integration technology appears that replaces the present integrated circuits, it is also possible to use an integrated circuit based on the technology.

Note that the invention of the present patent application is not limited to the above-described embodiments. In the embodiment, apparatuses have been described as an example, but the invention of the present application is not limited thereto, and is applicable to a terminal apparatus or a communication apparatus of a fixed-type or a stationary-type electronic equipment installed indoors or outdoors, for example, an AV equipment, a kitchen equipment, a cleaning or washing machine, an air-conditioning equipment, office equipment, a vending machine, and other household equipment.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of the present invention defined by claims, and embodiments obtained by suitably combining technical elements disclosed in the different embodiments are also included in the technical scope of the present invention.

Furthermore, a configuration in which a constituent element that achieves the same effect is substituted for the one that is described in the embodiments is also included in the technical scope of the present invention.

### INDUSTRIAL APPLICABILITY

The present invention can be preferably used in a base station apparatus, a terminal apparatus, and a communication method.

The present international application claims priority based on JP 2016-070493 filed on Mar. 31, 2016, and all the contents of JP 2016-070493 are incorporated in the present international application by reference.

### REFERENCE SIGNS LIST

1A Base station apparatus
2A, 2B Terminal apparatus
101 Higher layer processing unit
102 Control unit
103 Transmitter
104 Receiver
105 Transmit and/or receive antenna
1011 Radio resource control unit
1012 Scheduling unit
1031 Coding unit
1032 Modulation unit
1033 Downlink reference signal generation unit
1034 Multiplexing unit
1035 Radio transmitting unit
1041 Radio receiving unit
1042 Demultiplexing unit
1043 Demodulation unit
1044 Decoding unit
201 Higher layer processing unit
202 Control unit
203 Transmitter
204 Receiver
205 Channel state information generating unit
206 Transmit and/or receive antenna
2011 Radio resource control unit
2012 Scheduling information interpretation unit
2031 Coding unit
2032 Modulation unit
2033 Uplink reference signal generation unit
2034 Multiplexing unit
2035 Radio transmitting unit
2041 Radio receiving unit
2042 Demultiplexing unit
2043 Signal detection unit

1. A base station apparatus for communicating with a terminal apparatus, the base station apparatus comprising:
a transmitter configured to transmit a channel state information reference signal (CSI-RS) and configuration information of the CSI-RS to the terminal apparatus; and
a receiver configured to receive channel state information (CSI) related to the CSI-RS from the terminal apparatus,
wherein the CSI-RS is a periodic CSI-RS transmitted periodically or an aperiodic CSI-RS transmitted aperiodically, and
the configuration information of the CSI-RS includes information indicating a feedback information format for reporting the CSI.

2. The base station apparatus according to claim 1, wherein
the configuration information of the CSI-RS includes a CSI report type which is information indicating a type related to a report of the CSI, and a CSI-RS configuration information ID which is an ID of the configuration information of the CSI-RS, information of the periodic CSI-RS or information of the aperiodic CSI-RS, and
the CSI report type and the CSI-RS configuration information ID, the information of the periodic CSI-RS or the information of the aperiodic CSI-RS are associated with the information indicating the feedback information format for reporting the CSI.

3. The base station apparatus according to claim 2, wherein
the configuration information of the CSI-RS on the report of the CSI according to an implicit feedback information format and the configuration information of the CSI-RS on the report of the CSI according to an explicit feedback information format are configured for the terminal apparatus.

4. The base station apparatus according to claim 3, wherein
a CSI report cycle included in the configuration information of the CSI-RS on the report of the CSI according to the explicit feedback information format differs from a CSI report cycle included in the configuration information of the CSI-RS on the report of the CSI according to the implicit feedback information format.

5. The base station apparatus according to claim 3, wherein
the report of the CSI includes a wideband CSI report and a subband CSI report, and
the implicit feedback information format is configured in the wideband CSI report, and the implicit feedback information format is configured in the subband CSI report.

6. The base station apparatus according to claim 3, wherein the explicit feedback information format includes analog feedback.

7. A terminal apparatus for communicating with a base station apparatus, the terminal apparatus comprising:
a receiver configured to receive a channel state information reference signal (CSI-RS) and configuration information of the CSI-RS from the base station apparatus; and
a transmitter configured to transmit channel state information (CSI) related to the CSI-RS to the base station apparatus,
wherein the CSI-RS is a periodic CSI-RS transmitted periodically or an aperiodic CSI-RS transmitted aperiodically, and
the configuration information of the CSI-RS includes information indicating a feedback information format for reporting the CSI.

8. The terminal apparatus according to claim 7, wherein
the configuration information of the CSI-RS includes a CSI report type which is information indicating a type related to a report of the CSI, and a CSI-RS configuration information ID which is an ID of the configuration information of the CSI-RS, information of the periodic CSI-RS or information of the aperiodic CSI-RS, wherein
the CSI report type and the CSI-RS configuration information ID, the information of the periodic CSI-RS or the information of the aperiodic CSI-RS are associated with information indicating a feedback information format for reporting the CSI.

9. The terminal apparatus according to claim 8, wherein
the configuration information of the CSI-RS on the report of the CSI according to an implicit feedback information format and the configuration information of the CSI-RS on the report of the CSI according to an explicit feedback information format are configured by the base station apparatus.

10. The terminal apparatus according to claim 9, wherein
a CSI report cycle included in the configuration information of the CSI-RS on the report of the CSI according to the explicit feedback information format differs from a CSI report cycle included in the configuration information of the CSI-RS on the report of the CSI according to the implicit feedback information format.

11. The terminal apparatus according to claim 9, wherein
the report of the CSI includes a wideband CSI report and a subband CSI report, and
the implicit feedback information format is configured in the wideband CSI report, and the implicit feedback information format is configured in the subband CSI report.

12. The terminal apparatus according to claim 9, wherein the explicit feedback information format includes analog feedback.

13. A method for a base station apparatus to communicate with a terminal apparatus, the method comprising the steps of:
transmitting, to the terminal apparatus, a channel state information reference signal (CSI-RS) and configuration information of the CSI-RS; and
receiving channel state information (CSI) related to the CSI-RS from the terminal apparatus,
wherein the CSI-RS is a periodic CSI-RS transmitted periodically or an aperiodic CSI-RS transmitted aperiodically, and
the configuration information of the CSI-RS includes information indicating a feedback information format for reporting the CSI.

14. (canceled)
